(19) United States
(12) Patent Application Publication
(10) Pub. No.: US 2021/0064304 A1
(43) Pub. Date: Mar. 4, 2021

(54) INFORMATION PROCESSING APPARATUS, PRINT CONTROL METHOD, AND RECORDING MEDIUM

(71) Applicant: Konica Minolta, Inc., Chiyoda-ku (JP)

(72) Inventor: Akira INOUE, Tokyo (JP)

(73) Assignee: Konica Minolta, Inc., Chiyoda-ku (JP)

(21) Appl. No.: 16/943,651

(22) Filed: Jul. 30, 2020

(30) Foreign Application Priority Data
Aug. 29, 2019 (JP) 2019-156511

(51) Int. Cl. G06F 3/12; H04N 1/00; G06K 15/02

(52) U.S. Cl. CPC G06F 3/1208; G06K 15/1843; G06K 15/1836; H04N 1/0044

(57) ABSTRACT

An information processing apparatus causes an image forming apparatus to print document data. The information processing apparatus includes a hardware processor. The hardware processor obtains document data to be printed, determines whether a print preview process has been performed on the obtained document data, generates data for printing corresponding to the document data based on whether the print preview process has been performed, and transmits the data for printing toward the image forming apparatus.

### BACKGROUND

### 1. Field of the Invention

The present invention relates to an information processing apparatus, a print control method, and a recording medium.

### 2. Description of the Related Art

There is known an image forming apparatus, such as a printer, that forms an image on a sheet serving as a recording medium, using an electrophotographic recording method or the like. There is also known an image forming system in which a client personal computer (PC) transmits print data to an image forming apparatus such that the image forming apparatus forms an image.

There is also known an image forming system having a function for previewing print data. Referring now to FIG. 15, the operation of a related-art image forming system 1A having a preview function will be described. FIG. 15 illustrates the operation of the related-art image forming system 1A.

As illustrated in FIG. 15, the image forming system 1A includes a client PC 10A, a digital front end (DFE) 20A connected to the client PC 10A over a network, and an image forming apparatus 30 connected to the DFE 20A in a peer-to-peer manner. The image forming apparatus 30 is, for example, an electrophotographic image forming apparatus, and performs printing by forming an image on a sheet using toners of cyan (C), magenta (M), yellow (Y), and black (K).

The following describes an operation performed in the image forming system 1A to preview and print document data m1 that is, for example, created using a word processing application program on the client PC 10A and stored in a document file format in a storage (not illustrated). First, in the client PC 10A, a hardware processor (hereinafter referred to as an application AP2) that executes a print application program reads and obtains the created document data m1 from the storage (step S700). Then, the application AP2 performs a rasterization process on the obtained document data m1 to generate and display preview data (step S71). The rasterization process is a process for converting document data into image data of a bitmap image. Then, the application AP2 transmits the document data m1 to the DFE 20A (step S72).

The DFE 20A (specifically, its hardware processor) performs a rasterization process to convert the received document data m1 into print data of a bitmap image in a color mode of red (R), green (G), and blue (B) (step S73).

Then, the DFE 20A performs image processing to convert the print data of the RGB bitmap image into print data of a bitmap image in a color mode of CMYK (step S74). Then, the DFE 20A transmits the print data of the CMYK bitmap image to the image forming apparatus 30 as a print request (step S75). Then, the image forming apparatus 30 (specifically, its hardware processor) forms and prints an image on a sheet, based on the received print data of the CMYK bitmap image (step S76).

In the image forming system 1A, the preview data is only used for preview, and is not effectively utilized. Accordingly, there is known a system in which an image input/output controller (www server) is provided between a PC and a printer. The image input/output controller converts information to be printed, which is received from the PC, into a bitmap image for the printer, and stores the bitmap image. Upon receiving a preview instruction from the PC, the image input/output controller reads and transmits the bitmap image to the PC. Also, upon receiving a print instruction from the PC, the image input/output controller reads and transmits the bitmap image to the printer (Japanese Patent Application Publications No. 10-297057 (JP 10-297057 A)).

Depending on print data, it takes time to perform a rasterization process, so that it may take time to perform a preview process and a print process. However, in the system of JP 10-297057 A, all the rasterization processes are uniformly performed by the image input/output controller. Therefore, it is desired to more efficiently perform a rasterization process.

### SUMMARY

An object of the present invention is to efficiently perform a rasterization process on document data.

In order to achieve the above object, according to an aspect of the present invention, there is provided an information processing apparatus that causes an image forming apparatus to print document data, the information processing apparatus including:

a hardware processor that obtains document data to be printed, determines whether a print preview process has been performed on the obtained document data, generates data for printing corresponding to the document data based on whether the print preview process has been performed, and transmits the data for printing toward the image forming apparatus.

According to another aspect of the present invention, there is provided a print control method that causes an image forming apparatus to print document data, the print control method including:

controlling to obtain document data to be printed, determine whether a print preview process has been performed on the obtained document data, generate data for printing corresponding to the document data based on whether the print preview process has been performed, and transmit the data for printing toward the image forming apparatus.

According to still another aspect of the present invention, there is provided a non-transitory recording medium storing a computer readable program that causes a computer of an information processing apparatus to function as a hardware processor, the information processing apparatus causing an image forming apparatus to print document data, the hardware processor being configured to:

obtain document data to be printed, determine whether a print preview process has been performed on the obtained document data, generate data for printing corresponding to the document data based on whether the print preview process has been performed, and transmit the data for printing toward the image forming apparatus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 illustrates the schematic configuration of an image forming system according to an embodiment of the present invention.

FIG. 2 is a block diagram illustrating a main functional configuration of a client PC.

FIG. 3 is a block diagram illustrating a main functional configuration of a DFE.

FIG. 4 is a block diagram illustrating a main functional configuration of an image forming apparatus.

FIG. 5 illustrates a rasterizer table.

FIG. 6 is a flowchart illustrating a first preview process.

FIG. 7 is a flowchart illustrating a first print control process.

FIG. 8 illustrates the operation of the image forming system when the client PC performs a rasterization process.

FIG. 9 illustrates the operation of the image forming system when the DFE performs a rasterization process.

FIG. 10 is a flowchart illustrating a second preview process.

FIG. 11 is a flowchart illustrating a second print control process.

FIG. 12 illustrates the operation of the image forming system when the DFE performs a print control process.

FIG. 13 is a flowchart illustrating a third print control process.

FIG. 14 illustrates the operation of the image forming system when the DFE performs a preview process and a print control process.

FIG. 15 illustrates the operation of a related-art image forming system.

### DETAILED DESCRIPTION OF EMBODIMENTS

An embodiment and modifications of the present invention will be described in detail with reference to the accompanying drawings. However, the present invention is not limited to the examples illustrated in the drawings.

### EMBODIMENT

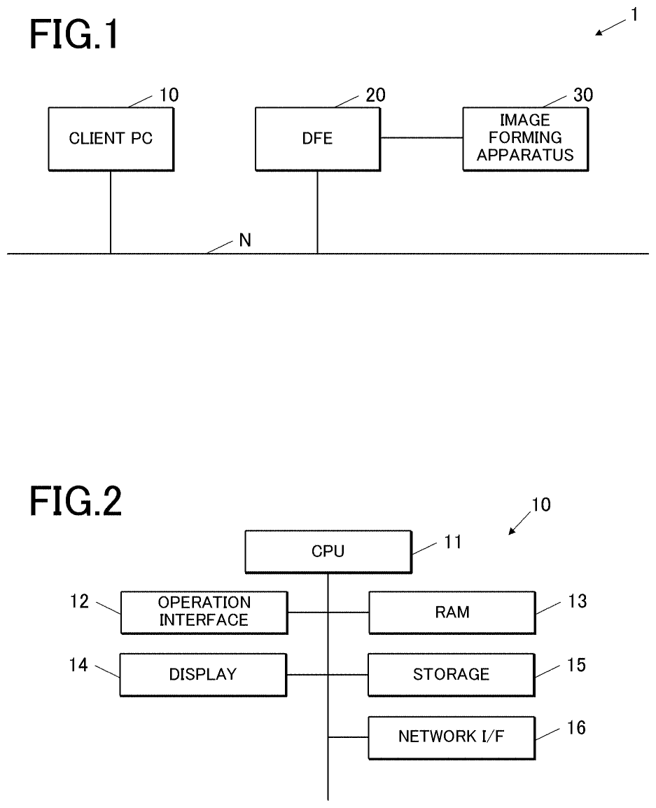

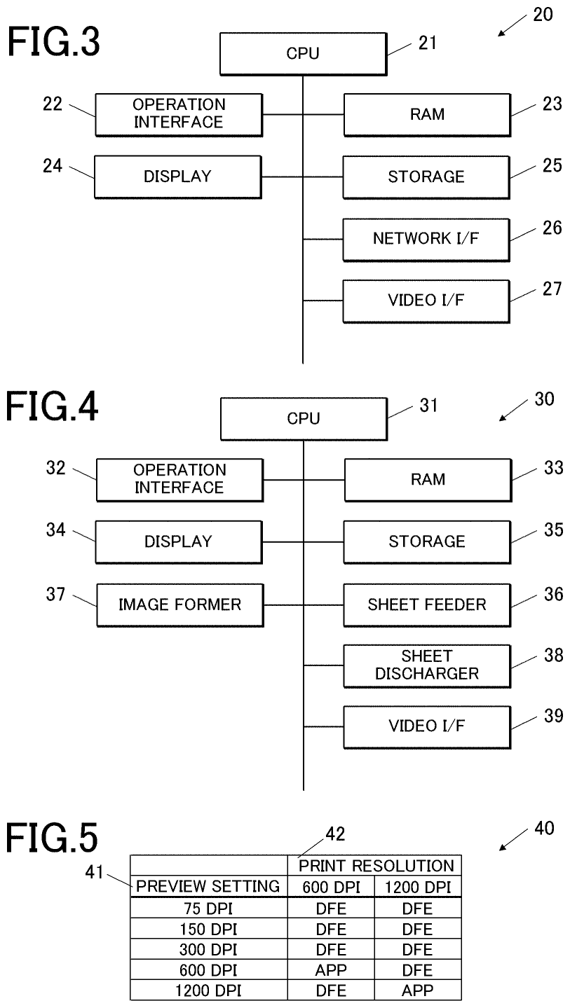

An embodiment of the present invention will be described with reference to FIGS. 1 to 9. First, the device configuration of an image forming system 1 according to the present embodiment will be described with reference to FIGS. 1 to 4. FIG. 1 illustrates a block diagram illustrating the schematic configuration of the image forming system 1 according to the present embodiment. FIG. 2 is a block diagram illustrating a main functional configuration of a client PC 10. FIG. 3 is a block diagram illustrating a main functional configuration of a DFE 20. FIG. 4 is a block diagram illustrating a main functional configuration of an image forming apparatus 30.

The image forming system 1 of the present embodiment is a print system that forms and prints an image of document data on a sheet, in response to an instruction from the user. As illustrated in FIG. 1, the image forming system 1 includes the client PC 10, the DFE 20, and the image forming apparatus 30. The client PC 10 and the DFE 20 are communicably connected to each other via a communication network N such as a local area network (LAN). The DFE 20 and the image forming apparatus 30 are communicably connected to each other in a peer-to-peer manner over a communication system such as a universal serial bus (USB).

The client PC 10 is used by the user. The client PC 10 is an information processing apparatus that receives a user input such as a print instruction with respect to the image forming apparatus 30 and a preview display instruction, generates preview data (preview image data), and transmits document data to be printed or the preview data to the DFE 20. The client PC 10 may be, but not limited to, a desktop PC, for example. The client PC 10 may be any other information processing apparatus (information terminal) such as a notebook PC and a tablet PC.

The DFE 20 is an information processing apparatus that converts document data or preview data transmitted from the client PC into print data, and causes the image forming apparatus 30 to print the print data. The DFE 20 may be, for example, an information processing apparatus such as a PC and a server.

The image forming apparatus 30 is a printing apparatus that forms and prints an image on a sheet based on print data transmitted from the DFE 20. The image forming apparatus 30 may be, not limited to, a color electrophotographic printer, for example. The image forming apparatus 30 may be any other image forming apparatus using a different image forming method such as an inkjet recording method, and may be any image forming apparatus of a different apparatus type such as a multifunction peripheral (MFP). Further, the image forming apparatus 30 may be an image forming apparatus that forms a monochrome image.

As illustrated in FIG. 2, the client PC 10 includes a central processing unit (CPU) 11, an operation interface 12, a random access memory (RAM) 13, a display 14, a storage 15, and a network interface (I/F) 16. These components of the client PC 10 are connected to each other via a bus.

The CPU 11 reads a specified program from among system programs and application programs stored in the storage 15, loads the program to the RAM 13, and performs various types of processing in accordance with the program loaded in the RAM 13.

The operation interface 12 includes a keyboard having various keys, and a pointing device such as a mouse. The operation interface 12 receives a user input via the keys and a position input, and outputs the operation information to the CPU 11. The operation interface 12 may include a touch panel disposed on the display screen of the display 14 so as to receive a user's touch input.

The RAM 13 provides a work memory space (work area), and stores temporary data.

The display 14 includes a display panel such as a liquid crystal display (LCD) and an electroluminescence (EL) display. Under the control of the CPU 11, the display 14 displays various types of display information.

The storage 15 includes a hard disk drive (HDD) and a solid state drive (SSD). The storage 15 is a storage that stores various programs and various types of data in a readable and writable manner. The storage 15 stores especially an application program serving as a print driver for causing the CPU 11 to function as an application AP1 (described below).

The network I/F 16 is a communication interface such as a network card connected to a communication network N. The network I/F 16 transmits and receives information to and from apparatuses such as the DFE 20 on the communication network N.

As illustrated in FIG. 3, the DFE 20 includes a CPU 21, an operation interface 22, a RAM 23, a storage 25, a display 24, a network I/F 26, and a video I/F 27. These components of the DFE 20 are connected to each other via a bus.

The CPU 21 reads a specified program from among system programs and application programs stored in the storage 25, loads the program to the RAM 23, and performs various types of processing in accordance with the program loaded in the RAM 23.

The operation interface 22 includes a keyboard having various keys, and a pointing device such as a mouse. The operation interface 22 receives a user input via the keys and a position input, and outputs the operation information to the CPU 21. The operation interface 22 may include a touch panel disposed on the display screen of the display 24 so as to receive a user's touch input.

The RAM 23 provides a work memory space (work area), and stores temporary data.

The display 24 includes a display panel such as an LCD and an EL display. The display 24 displays various types of display information under the control of the CPU 21.

The storage 25 includes an HDD and an SSD. The storage 25 is a storage that stores various programs and various types of data in a readable and writable manner. The storage 25 especially stores a program for executing the operation of the DFE 20 (described below).

The network I/F 26 is a communication interface such as a network card connected to a communication network N. The network I/F 26 transmits and receives information to and from apparatuses such as the client PC 10 on the communication network N.

The video I/F 27 is a communication interface connected to the image forming apparatus 30. The video I/F 27 transmits and receives information to and from the image forming apparatus 30 through a cable.

As illustrated in FIG. 4, the image forming apparatus 30 includes a CPU 31, an operation interface 32, a RAM 33, a display 34, a storage 35, a sheet feeder 36, an image former 37, a sheet discharger 38, and a video I/F 39. These components of the image forming apparatus 30 are connected to each other via a bus.

The CPU 31 reads a specified program from among system programs and application programs stored in the storage 35, loads the program to the RAM 33, and performs various types of processing in accordance with the program loaded in the RAM 33.

The operation interface 32 includes various keys. The operation interface 32 receives various settings entered by the user via the keys, and outputs the operation information to the CPU 31.

The RAM 33 provides a work memory space (work area), and stores temporary data.

The display 34 includes a display panel such as an LCD and an EL display. The display 34 displays various types of display information under the control of the CPU 31.

The storage 35 includes a flash memory. The storage 35 is a storage that stores various programs and various types of data in a readable and writable manner. The storage 35 especially stores a program for executing the operation of the image forming apparatus 30 (described below).

The sheet feeder 36 includes a sheet feed tray, a manual feed tray, and a conveyance roller. Under the control of the CPU 31, the sheet feeder 36 picks up a sheet from the sheet feed tray or the manual feed tray, and conveys the sheet to the image former 37.

The image former 37 includes image forming units of four colors of C, M, Y, and K, and a fixer. The image former 37 forms a toner image on a sheet conveyed from the sheet feeder 36, based on print data, using the image forming units of four colors of C, M, Y, and K, under the control of the CPU 31, and fixes the toner image on the sheet using the fixer.

Each of the image forming units of the respective colors of C, M, Y, and K includes a photoconductor drum, a charger, an exposure, a developer, and a cleaner. For example, in the image forming unit for color cyan, the charger charges the photoconductor drum, which is a rotating conductive cylinder. The exposer exposes the photoconductor drum in accordance with the print data of the color cyan so as to form an electrostatic latent image. Then, the developer supplies toner of the color cyan to the photoconductor drum with the electrostatic latent image formed thereon so as to transfer and develop the image onto the transfer target. The cleaner collects the residual toner on the photoconductor drum. The image forming units for the other colors have the same configuration.

In the case where electrophotographic image formation by the image former 37 is of a tandem system, the image forming units of the respective colors of C, M, Y and K are arranged in series in the sheet conveyance direction. The image forming units of the respective colors transfer toner images of the respective colors to a transfer target sheet being conveyed such that the toner images are superposed on each other.

In the case where electrophotographic image formation by the image former 37 is of a four-cycle system, the image former 37 further includes an intermediate transfer belt serving as an intermediate transfer body, and a transfer roller. The image forming units of the respective colors of C, M, Y and K transfer toner images of the respective colors to the intermediate transfer belt such that the toner images are superposed on each other. Then, the transfer roller transfers the toner images from the intermediate transfer belt to a sheet. The toner images of the four colors transferred to the sheet are heated and pressed so as to be fixed on the sheet by the fixer.

The sheet discharger 38 includes a sheet discharge tray and a conveyance roller. Under the control of the CPU 31, the sheet discharger 38 conveys the sheet with an image formed by the image former 37 to the sheet discharge tray so as to discharge the sheet. The sheet discharger 38 may include a flipper that turns over a sheet with an image formed on one side thereof by the image former 37 and feeds again the sheet to the image former 37. With this flipper, it is possible to form images on both sides of a sheet.

The video I/F 39 is a communication interface connected to the DFE 20. The video I/F 39 transmits and receives information to and from the DFE 20 through a cable.

In the following, information stored in advance in the storage 15 of the client PC 10 will be described with reference to FIG. 5. FIG. 5 illustrates a rasterizer table 40.

The rasterizer table 40 illustrated in FIG. 5 is stored in the storage 15 in advance. The rasterizer table 40 includes the following items: a preview setting 41, and a print resolution 42. The preview setting 41 indicates the resolution [dots per inch (DPI)] of preview data for preview. The print resolution 42 indicates the resolution [DPI] at which printing is actually performed by the image forming apparatus 30. In the rasterizer table 40, DFE (DFE 20) or APP (application AP1 (described below)) is specified in accordance with the set value of the preview setting 41 and the set value of the print resolution 42.

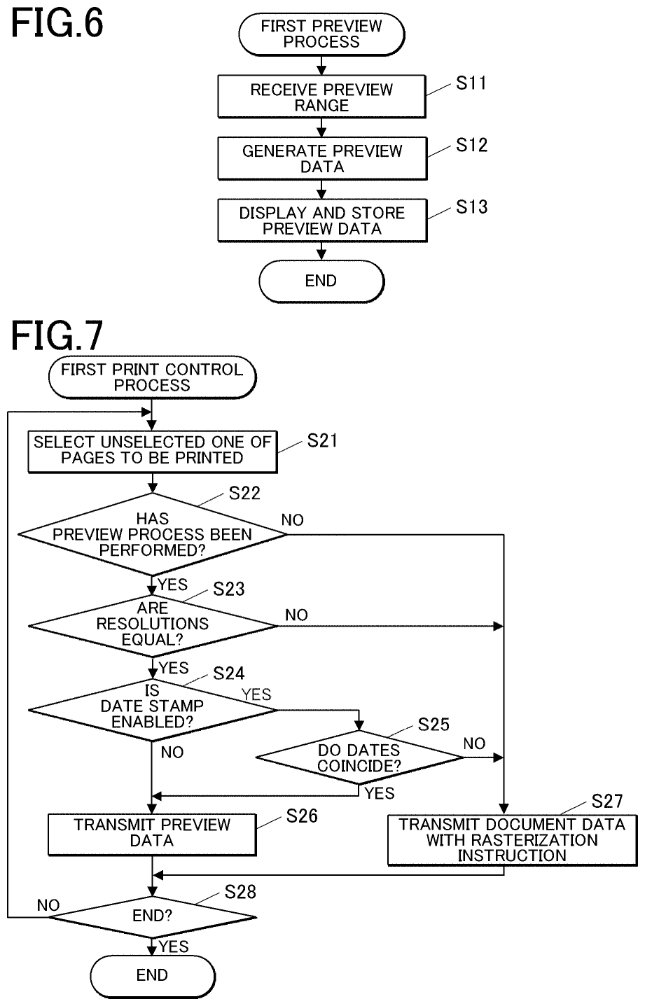

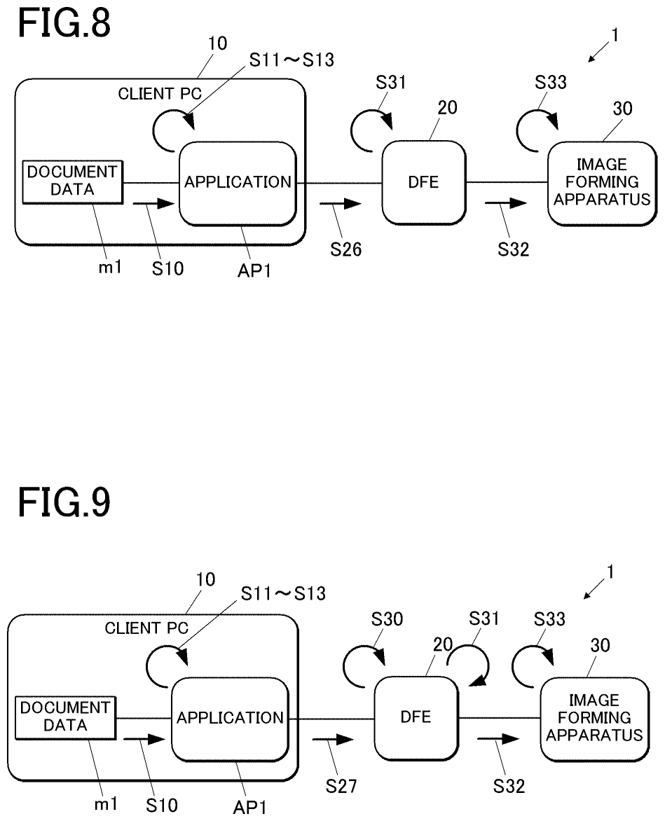

In the following, the operation of the image forming system 1 will be described with reference to FIGS. 6 and 9. FIG. 6 is a flowchart illustrating a first preview process. FIG. 7 is a flowchart illustrating a first print control process. FIG. 8 illustrates the operation of the image forming system 1 when the client PC 10 performs a rasterization process. FIG. 9 illustrates the operation of the image forming system 1 when the DFE 20 performs a rasterization process.

In the client PC 10, document data m1 including a plurality of pages in a document file format is created and stored in the storage 15 in advance according to user inputs via the operation interface 12, by execution of a word processing application program, for example. The document data m1 may include a print stamp indicating the print date.

In the client PC 10, for example, upon receiving an instruction entered by the user via the operation interface 12 to start a print driver for the document data m1 the CPU 11 starts to operate as the application AP1 according to the application program stored in the storage 15 and serving as a print driver in the present embodiment.

Then, in the client PC 10, for example, upon receiving an instruction entered by the user via the operation interface 12 to execute a preview process for the document data, the CPU 11 (application AP1) executes the first preview process illustrated in FIG. 6.

First, the CPU 11 receives a preview range of the document data entered by the user via the operation interface 12 (step S11). The preview range may be set to any range in units of pages to be previewed. For example, the preview range may be only a front page, all the pages, or pages of one or more page numbers.

Then, the CPU 11 performs a rasterization process for preview, on page data in the preview range of the document data entered in step S11, so as to generate preview data of a bitmap image (step S12). In step S12, for example, the resolution of preview data may be fixed in advance, or may be set to any resolution according to a user input via the operation interface 12.

Then, the CPU 11 displays the preview data generated in step S12 on the display 14, and stores the preview data in the RAM 13 or the storage 15 (step S13). Thus, the first preview process is ended.

Further, in the client PC 10, while the print driver is running, the CPU 11 (application AP1) sets a print resolution in the image forming apparatus 30 for the document data m1 to be printed, according to the print resolution entered by the user via the operation interface 12, and stores the print resolution in the RAM 13. Then, in the client PC 10, for example, upon receiving a print instruction entered by the user via the operation interface 12, the CPU 11 (application AP1) executes the first print control process illustrated in FIG. 7.

First, the CPU 11 selects one of unselected pages from the top of the document data m1 to be printed (step S21). Then, the CPU 11 determines whether a preview process has been performed on the page selected in step S21, based on whether preview data corresponding to the page selected in step S21 is present (has been generated) and is stored in the RAM 13 or the storage 15 (step S22). If a preview process has been performed (step S22; YES), the CPU 11 refers to the rasterizer table 40 stored in the storage 15, and determines whether the resolution of the preview data corresponding to the page selected in step S21 and the print resolution stored in the RAM 13 are equal (step S23).

If the resolution of the preview data and the print resolution are equal (step S23; YES), the CPU 11 determines whether a date stamp function is enabled on (a date stamp is included in) the preview data corresponding to the page selected in step S21 (step S24). If the date stamp function is enabled (step S24; YES), the CPU 11 acquires a date stamp from the preview data corresponding to the page selected in step S21, and determines whether the date of the date stamp coincides with the current date (print date) (step S25).

If the date stamp function is not enabled (step S24; NO), or if the dates coincide (step S25; YES), the CPU 11 reads preview data corresponding to the page selected in step S21 from the storage 15, and transmits the read preview data corresponding to the page to the DFE 20 via the network I/F 16 (step S26).

If a preview process has not been performed (step S22; NO), if the resolution of the preview data and the print resolution are not equal (step S23; NO), or if the dates do not coincide (step S25; NO), the CPU 11 reads document data corresponding to the page selected in step S21 from the storage 15, and transmits the read document data for the page, together with an instruction to execute a rasterization process, to the DFE 20 via the network I/F 16 (step S27).

After step S26 or S27, the CPU 11 determines whether there is no page to be selected in step S21 and the first print control process is to be ended (step S28). If the process is not to be ended (step S28; NO), the process returns to step S21. If the process is to be ended (step S28; YES), the first print control process is ended.

Referring now to FIG. 8, the operation of the image forming system 1 when preview data is transmitted in step S26 will be described. As illustrated in FIG. 8, first, in the client PC 10A, the CPU 11 (application AP1) reads and obtains the created document data m1 from the storage 15 (step S10). Then, the CPU 11 executes the first preview process and the first print control process.

Then, in step S26, the CPU 11 transmits preview data corresponding to a page of the document data m1 to the DFE 20. In response to step S26, the CPU 21 of the DFE 20 receives the preview data from the client PC 10, via the network I/F 26.

Then, the CPU 21 of the DFE 20 performs image processing to convert the received preview data of an RGB bitmap image into print data of a CMYK bitmap image (step S31). The image processing in step S31 includes color conversion for the image forming apparatus 30. In the image forming apparatus 30, the maximum toner amount of each of the CMYK colors is determined in advance, and color conversion for the image forming apparatus 30 is color conversion in accordance with the maximum toner amount of each color.

Then, the CPU 21 of the DFE 20 transmits the print data generated in step S31 to the image forming apparatus 30, via the video I/F 27 (step S32). In response to step S32, the CPU 31 of the image forming apparatus 30 receives the print data from the DFE 20, via the video I/F 39.

Then, the CPU 31 of the image forming apparatus 30 controls the sheet feeder 36, the image former 37, and the sheet discharger 38 to form and print an image on a sheet, based on the received print data (step S33).

Referring now to FIG. 9, the operation of the image forming system 1 when document data is transmitted in step S27 will be described. As illustrated in FIG. 9, first, in the client PC 10A, the CPU 11 (application AP1) reads and obtains the created document data m1 from the storage 15 (step S10), and executes the first preview process and the first print control process.

Then, in step S27, the CPU 11 transmits document data corresponding to a page of the document data m1, together with an instruction to execute a rasterization process, to the DFE 20. In response to step S27, the CPU 21 of the DFE 20 receives the document data together with the instruction to execute a rasterization process, from the client PC 10 via the network I/F 26.

Then, the CPU 21 of the DFE 20 performs a rasterization process to convert the received document data into an RGB bitmap image data (step S30). Then, the CPU 21 of the DFE 20 performs image processing to convert the generated RGB bitmap image data into print data of a CMYK bitmap image (step S31). Steps S32 and S33 of FIG. 9 are the same as those of FIG. 8.

As described above, according to the present embodiment, the client PC 10 causes the image forming apparatus 30 to print document data. The client PC 10 includes the CPU 11 that obtains document data to be printed, determines whether a preview process has been performed on the obtained document data, generates data for printing (preview data or document data) corresponding to the document data based on whether a preview process has been performed, and transmits the data for printing to the DFE 20 connected to the image forming apparatus 30.

Therefore, the preview data that has been rasterized in the preview process is effectively utilized. This makes it possible to efficiently perform a rasterization process on document data.

If a preview process has not been performed on the obtained document data, the CPU 11 specifies the obtained document data as data for printing. Therefore, even if a preview process has not been performed, it is possible to transmit the document data as data for printing to the DFE 20 and reliably perform a rasterization process thereon.

If a preview process has been performed on the obtained document data, the CPU 11 obtains preview data generated by the preview process, and specifies the obtained preview data as data for printing. Therefore, if a preview process has been performed, the preview data that has been rasterized is effectively utilized as data for printing. This makes it possible to efficiently perform a rasterization process on document data.

If a preview process has been performed on the obtained document data, and if the preview process has been performed under a predetermined condition, the CPU 11 obtains preview data generated by the preview process, and specifies the obtained preview data as data for printing. The predetermined condition is that the resolution in the preview process is equal to the print resolution of the image forming apparatus 30. Therefore, the resolution in the preview process is equal to the print resolution of the image forming apparatus 30, so that printing is performed at an appropriate resolution.

The CPU 11 determines whether another predetermined condition is satisfied, that is, whether the print stamp function on the preview data is enabled. If the print stamp function is not enabled, the CPU 11 obtains the preview data, and specifies the obtained preview data as data for printing. Accordingly, if the print stamp function is enabled and the print stamp of the preview data differs from the print stamp of the document data, the preview data is prevented from being printed.

The CPU 11 determines whether another predetermined condition is satisfied, that is, whether time information (date) of the print stamp function on the preview data coincides with current time information (date). If the time information (date) of the print stamp function on the preview data coincides with the current time information (date), the CPU 11 obtains the preview data, and specifies the obtained preview data as data for printing. Accordingly, if the time information (date) of the print stamp of the preview data differs from the time information (date) of the print stamp of the document data, the preview data is prevented from being printed.

The document data includes a plurality of pages. The CPU 11 obtains the document data to be printed in units of pages, determines whether a preview process has been performed on the obtained document data, generates data for printing (preview data or document data) corresponding to the document data based on whether a preview process has been performed, and transmits the data for printing to the DFE 20 connected to the image forming apparatus 30. Therefore, the pages of the preview data that has been rasterized in the preview process are effectively utilized. This makes it possible to more efficiently perform a rasterization process on document data in units of pages.

The preview process is performed by the client PC 10. Therefore, the client PC 10 can easily obtain preview data, so that the processing load on the DFE 20 is reduced.

### First Modification

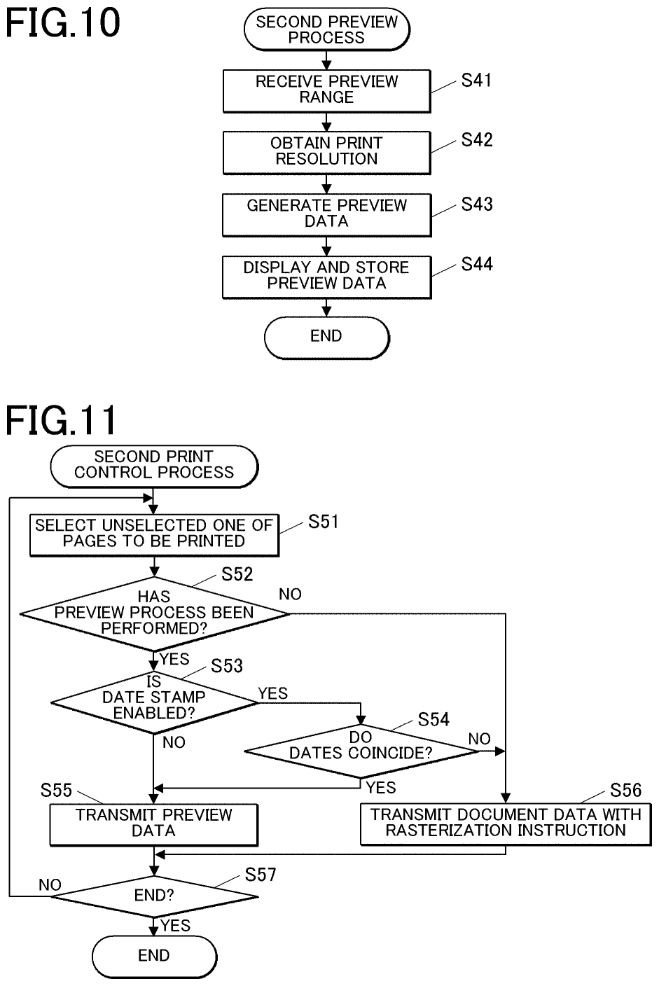

A first modification of the above embodiment will be described with reference to FIGS. 10 and 11. FIG. 10 is a flowchart illustrating a second preview process. FIG. 11 is a flowchart illustrating a second print control process.

In the above embodiment, if the resolution of preview data is equal to the print resolution, printing is performed using the preview data. Meanwhile, in the present modification, preview data is generated to have a resolution equal to the print resolution.

In the present modification, the image forming system 1 is used as in the above embodiment. However, the storage 15 of the client PC 10 stores application programs for executing a second preview process and a second print control process (described below).

In the following, the operation of the image forming system 1 will be described with reference to FIGS. 10 and 11. In the client PC 10, document data m1 including a plurality of pages in a document file format is created and stored in the storage 15 in advance according to user inputs via the operation interface 12, by execution of a word processing application program, for example. The document data m1 may include a print stamp indicating the print date.

In the client PC 10, for example, upon receiving an instruction entered by the user via the operation interface 12 to start a print driver for the document data m1 the CPU 11 starts to operate as the application AP1 according to the application program stored in the storage 15 and serving as a print driver in the present embodiment.

Further, in the client PC 10, while the print driver is running, the CPU 11 (application AP1) sets a print resolution in the image forming apparatus 30 for the document data m1 to be printed, according to the print resolution entered by the user via the operation interface 12, and stores the print resolution in the RAM 13.

Then, in the client PC 10, for example, upon receiving an instruction entered by the user via the operation interface 12 to preview the document data m1 the CPU 11 (application AP1) executes the second preview process illustrated in FIG. 10.

First, the CPU 11 executes step S41. Step S41 is the same as step S11 of the first preview process of FIG. 6. Then, the CPU 11 obtains the print resolution set and stored in the RAM 13 (step S42). Then, the CPU 11 performs a rasterization process for preview, on page data in the preview range of the document data m1 entered in step S41, at a resolution equal to the print resolution obtained in step S42, so as to generate preview data of a bitmap image (step S43). Step S44 is the same as step S13 of the first preview process of FIG. 6.

Then, in the client PC 10, for example, upon receiving a print instruction entered by the user via the operation interface 12, the CPU 11 (application AP1) executes the second print control process illustrated in FIG. 11.

Steps S51 to S57 of the second print control process are the same as steps S21, S22, and S24 to S28 of the first print control process of FIG. 7.

As described above, according to the present modification, when the preview process is performed by the client PC 10, the preview process is performed at a resolution equal to the print resolution of the image forming apparatus 30. Therefore, the processing load on the client PC 10 and the processing load on the DFE 20 while performing print control are reduced.

### Second Modification

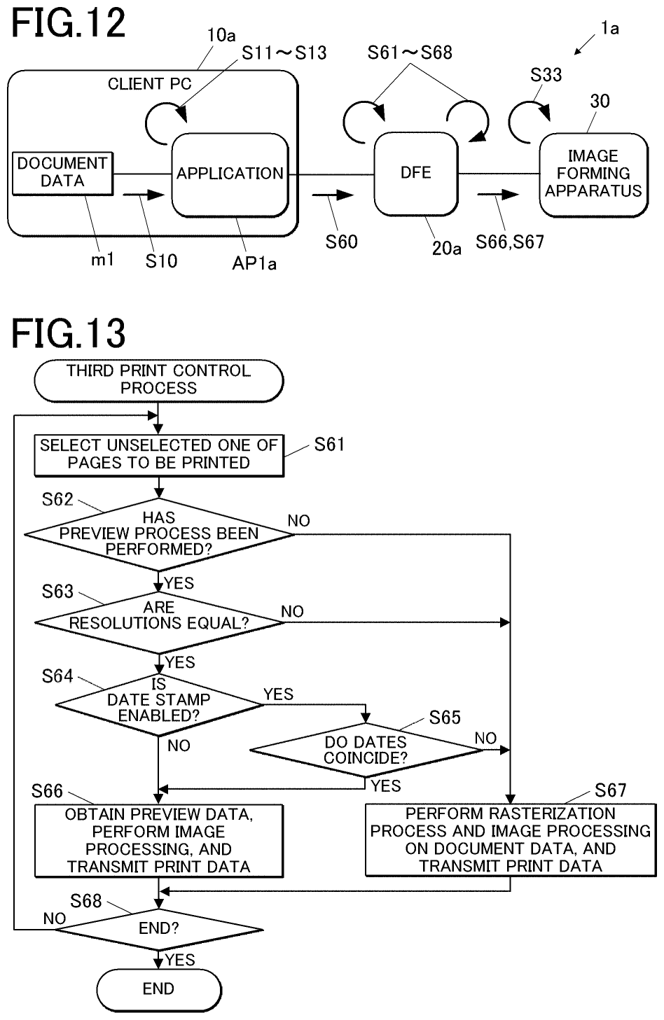

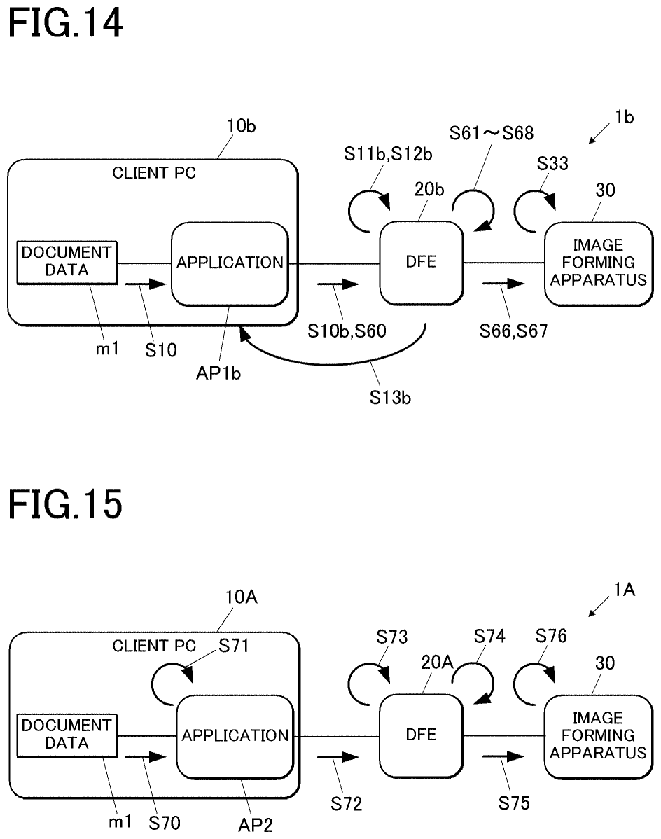

A second modification of the above embodiment will be described with reference to FIGS. 12 to 14. FIG. 12 illustrates the operation of an image forming system 1a when a DFE 20a performs a print control process. FIG. 13 is a flowchart illustrating a third print control process. FIG. 14 illustrates the operation of the image forming system 1b when a DFE 20b performs a preview process and a print control process.

In the above embodiment, the client PC 10 performs a preview process and a print control process. Meanwhile, in the present modification, the DFE 20a performs a print control process.

Referring first to FIG. 12, according to a first apparatus configuration of the present modification, the image forming system 1a is used in place of the image forming system 1 of the above embodiment. The image forming system 1a includes a client PC 10a, the DFE 20a, and the image forming apparatus 30.

The client PC 10a has the same functional configuration as the client PC 10 of the above embodiment, and executes a first preview process. The DFE 20a has the same functional configuration as the DFE 20 of the above embodiment, and executes a third print control process (described below). The rasterizer table 40 and a third print control program for executing the third print control process are stored in a storage 25.

In the following, the operation of the image forming system 1a will be described with reference to FIGS. 12 and 13. First, in the client PC 10a, a CPU 11 starts to operate as an application AP1a, according to an application program serving as a print driver, and executes the same first preview process as that of FIG. 6.

Then, in the DFE 20a, upon receiving document data m1 to be printed from the client PC 10a (application AP1a) via a network I/F 26 and storing the document data m1 in the storage 25 (step S60), the CPU 21 executes the third print control process, in association with the third print control program read from the storage 25 and appropriately loaded to the RAM 23.

As illustrated in FIG. 13, the CPU 21 executes steps S61 to S65. Steps S61 to S65 correspond to steps S21 to S25 of FIG. 6, but are executed by the CPU 21. Also, in steps S62 to S64, the CPU 21 refers to the rasterizer table 40 stored in the storage 25; requests the client PC 10a (application AP1a) for information as to whether preview data of a page to be printed is stored in the RAM 13, the resolution, and information as to whether the date stamp function is enabled, so as to obtain these pieces of information, via a network I/F 26; and uses the obtained pieces of information.

If the date stamp function is not enabled (step S64; NO), or if the dates coincide (step S65; YES), the CPU 21 requests the client PC 10a (application AP1a) for preview data corresponding to the page selected in step S61 so as to obtain the preview data via the network I/F 26, performs image processing on the obtained preview data of the page so as to generate print data, and transmits the generated print data for the page to the image forming apparatus 30 via the video I/F 27 (step S66).

If a preview process has not been performed (step S62; NO), if the resolution of the preview data and the print resolution are not equal (step S63; NO), or if the dates do not coincide (step S65; NO), the CPU 11 reads document data corresponding to the page selected in step S61 from the storage 25, performs a rasterization process and image processing on the read document data corresponding to the page so as to generate print data, and transmits the generated print data to the image forming apparatus 30 via the video I/F 27 (step S67).

In step S33, the CPU 31 of the image forming apparatus 30 forms and prints an image on a sheet, based on the received print data.

Referring next to FIG. 14, according to a second apparatus configuration of the present modification, an image forming system 1b is used in place of the image forming system 1 of the above embodiment. The image forming system 1b includes a client PC 10b, the DFE 20b, and the image forming apparatus 30.

The client PC 10b has the same functional configuration as the client PC 10 of the above embodiment. The DFE 20b has the same functional configuration as the DFE 20 of the above embodiment, and executes a third preview process similar to the first preview process of the above embodiment, and a third print control process. The rasterizer table 40, a third preview program for executing the third preview process, and a third print control program for executing the third print control process are stored in a storage 25.

In the following, the operation of the image forming system 1b will be described with reference to FIG. 14. First, in the client PC 10b, the CPU 11 starts to operate as an application AP1b according to an application program serving as a print driver, and transmits document data to be previewed to the DFE 20b, via the network I/F 16 (step S10b).

Then, a CPU 21 of the DFE 20b receives the document data to be previewed from the client PC 10b (application AP1b) via a network I/F 26, and stores the document data in the storage 25. Then, the CPU 21 receives the preview range of the document data m1 entered by the user on the client PC 10b (application AP1b), from the client PC 10b (application AP1b) via the network I/F 26 (step S11b).

Then, the CPU 21 performs a rasterization process for preview, on page data in the preview range, which is entered in step S11b, of the document data m1 stored in the storage 25, so as to generate preview data of a bitmap image, and stores the preview data in the RAM 23 or the storage 25 (step S12b). Then, the third preview process ends. A part of the RAM 23 or the storage 25 is available to the client PC 10b as a shared memory with the client PC 10b, and stores the preview data generated in step S12b. Then, the CPU 11 of the client PC 10b reads and receives the preview data generated in step S12b from the RAM 23 or the storage 25 of the client PC 10b (application AP1b), via the network I/F 16, and displays the preview data on the display 14 (step S13b).

Then, the CPU 21 receives the document data m1 from the client PC 10b (application AP1b) via the network I/F 26, stores the document data m1 in the storage 25 (step S60), and executes the third print control process. Note that, in steps S62 to S64, the CPU 21 obtains information as to whether preview data of a page to be printed is stored in the RAM 23 or the storage 25, the resolution, and information as to whether the date stamp function is enabled.

As described above, according to the present modification, the DFE 20 causes the image forming apparatus 30 to print document data. The DFE 20 includes the CPU 21 that obtains document data to be printed, determines whether a preview process has been performed on the obtained document data, generates data for printing (print data) corresponding to the document data based on whether a preview process has been performed, and transmits the data for printing to the image forming apparatus 30.

Therefore, the preview data that has been rasterized in the preview process is effectively utilized. This makes it possible to efficiently perform a rasterization process on document data.

If a preview process has not been performed on the obtained document data, the CPU 21 performs a rasterization process and image processing on the document data so as to generate data for printing (print data). Therefore, even if a preview process has not been performed, it is possible to transmit the document data subjected to the rasterization process and image processing to the image forming apparatus 30 and reliably perform printing.

Meanwhile, if a preview process has been performed on the obtained document data, the CPU 21 obtains preview data generated by the preview process, and performs image processing on the preview data so as to generate data for printing (print data). Therefore, if a preview process has been performed, the preview data that has been rasterized is effectively utilized as data for printing. This makes it possible to efficiently perform a rasterization process on document data.

If a preview process has been performed on the obtained document data, and if the preview process has been performed under a predetermined condition, the CPU 21 obtains preview data generated by the preview process, and performs image processing on the preview data so as to generate data for printing (print data). The predetermined condition is that the resolution in the preview process is equal to the print resolution of the image forming apparatus 30. Therefore, the resolution in the preview process is equal to the print resolution of the image forming apparatus 30, so that printing is performed at an appropriate resolution.

The CPU 21 determines whether another predetermined condition is satisfied, that is, whether the print stamp function on the preview data is enabled. If the print stamp function is not enabled, the CPU 21 obtains the preview data, and specifies the obtained preview data as data for printing (print data). Accordingly, if the print stamp function is enabled and the print stamp of the preview data differs from the print stamp of the document data, the preview data is prevented from being printed.

The CPU 21 determines whether another predetermined condition is satisfied, that is, whether time information (date) of the print stamp function on the preview data coincides with current time information (date). If the time information (date) of the print stamp function on the preview data coincides with the current time information (date), the CPU 21 obtains the preview data, and specifies the obtained preview data as data for printing. Accordingly, if the time information (date) of the print stamp of the preview data differs from the time information (date) of the print stamp of the document data, the preview data is prevented from being printed.

The document data includes a plurality of pages. The CPU 21 obtains the document data to be printed in units of pages, determines whether a preview process has been performed on the obtained document data, generates data for printing (print data) corresponding to the document data based on whether a preview process has been performed, and transmits the data for printing to the image forming apparatus 30. Therefore, the pages of the preview data that has been rasterized in the preview process are effectively utilized. This makes it possible to more efficiently perform a rasterization process on document data in units of pages.

The preview process is performed by the client PC 10 or the DFE 20. Therefore, the client PC 10 or the DFE 20 can easily obtain preview data, so that the processing load on the DFE 20 or the client PC 10 is reduced.

When the preview process is performed by the DFE 20, generated preview data is stored in the RAM 23 or the storage 25 shared with the client PC 10. Therefore, the client PC 10 can easily obtain the preview data.

Note that the above embodiment and modifications are merely examples of an information processing apparatus, a print control method, and a program according to a preferred embodiment of the present invention, and the present invention is not limited thereto. For example, at least two of the above embodiment and the first and second modifications may be appropriately combined.

The detailed configuration and detailed operation of the components of the image forming system 1 of the above embodiment may be appropriately modified without departing from the scope of the present invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese patent application No. 2019-156511, filed on Aug. 29, 2019, is incorporated herein by reference in its entirety.

What is claimed is:

1. An information processing apparatus that causes an image forming apparatus to print document data, the information processing apparatus comprising:
a hardware processor that obtains document data to be printed, determines whether a print preview process has been performed on the obtained document data, generates data for printing corresponding to the document data based on whether the print preview process has been performed, and transmits the data for printing toward the image forming apparatus.

2. The information processing apparatus according to claim 1, wherein when the print preview process has not been performed on the obtained document data, the hardware processor specifies the obtained document data as the data for printing, or performs a rasterization process and image processing on the document data to generate the data for printing.

3. The information processing apparatus according to claim 1, wherein when the print preview process has been performed on the obtained document data, the hardware processor obtains preview image data generated by the print preview process, and specifies the obtained preview image data as the data for printing, or performs image processing on the preview image data to generate the data for printing.

4. The information processing apparatus according to claim 3, wherein when the print preview process has been performed on the obtained document data, and when the print preview process has been performed under a predetermined condition, the hardware processor obtains preview image data generated by the print preview process, and specifies the obtained preview image data as the data for printing, or performs image processing on the preview image data to generate the data for printing.

5. The information processing apparatus according to claim 4, wherein when the hardware processor determines the predetermined condition is satisfied by determining that a resolution in the print preview process is equal to a print resolution of the image forming apparatus, the hardware processor obtains preview image data generated by the print preview process, and specifies the obtained preview image data as the data for printing, or performs image processing on the preview image data to generate the data for printing.

6. The information processing apparatus according to claim 4, wherein the hardware processor determines whether the predetermined condition is satisfied by determining whether a print stamp function of the preview image data is enabled, and wherein when the print stamp function is not enabled, the hardware processor obtains the preview image data, and specifies the obtained preview image data as the data for printing, or performs image processing on the preview image data to generate the data for printing.

7. The information processing apparatus according to claim 4, wherein the hardware processor determines whether the predetermined condition is satisfied by determining whether time information of the print stamp function of the preview image data and current time information coincide, and wherein when the time information of the print stamp function of the preview image data and the current time information coincide, the hardware processor obtains the preview image data, and specifies the obtained preview image data as the data for printing, or performs image processing on the preview image data to generate the data for printing.

8. The information processing apparatus according to claim 1,
wherein the document data includes a plurality of pages; and
wherein the hardware processor obtains the document data to be printed in units of pages, determines whether a print preview process has been performed on the obtained document data, generates data for printing corresponding to the document data based on whether the print preview process has been performed, and transmits the data for printing toward the image forming apparatus.

9. The information processing apparatus according to claim 1, wherein the print preview process is performed by the information processing apparatus, or by another information processing apparatus that has transmitted the document data to the information processing apparatus.

10. The information processing apparatus according to claim 1, wherein when the print preview process is performed by the information processing apparatus, the print preview process is performed at a resolution equal to a print resolution of the image forming apparatus.

11. The information processing apparatus according to claim 1, wherein when the print preview process is performed by the information processing apparatus, generated preview image data is stored in a storage shared with another information processing apparatus that has transmitted the document data.

12. A print control method that causes an image forming apparatus to print document data, the print control method comprising:
controlling to obtain document data to be printed, determine whether a print preview process has been performed on the obtained document data, generate data for printing corresponding to the document data based on whether the print preview process has been performed, and transmit the data for printing toward the image forming apparatus.

13. A non-transitory recording medium storing a computer readable program that causes a computer of an information processing apparatus to function as a hardware processor, the information processing apparatus causing an image forming apparatus to print document data, the hardware processor being configured to:
obtain document data to be printed, determine whether a print preview process has been performed on the obtained document data, generate data for printing corresponding to the document data based on whether the print preview process has been performed, and transmit the data for printing toward the image forming apparatus.
